(19) United States
(12) Patent Application Publication
(10) Pub. No.: US 2025/0315608 A1
(43) Pub. Date: Oct. 9, 2025

(54) USING INTERACTION DATA TO DYNAMICALLY REPLACE CONTENT IN A DOCUMENT OBJECT MODEL

(71) Applicant: Capital One Services, LLC, McLean, VA (US)

(72) Inventor: Bryan TAMAYO, Allen, TX (US)

(21) Appl. No.: 18/625,847

(22) Filed: Apr. 3, 2024

(51) Int. Cl. G06F 40/197; G06F 40/14; G06F 40/166

(52) U.S. Cl. CPC G06F 40/197; G06F 40/14; G06F 40/166

(57) ABSTRACT

In some implementations, a user device may receive a web page that includes content organized in a plurality of containers of a document object model (DOM) associated with the web page. The user device may render, in connection with an initial page load, the web page for presentation in a user interface. The user device may monitor interaction data relating to a use of the user interface. The user device may identify, in accordance with the interaction data, a container of the plurality of containers of the DOM that contains original content that has been viewed. The user device may load, asynchronously to the initial page load, replacement content into the container of the DOM to replace the original content with the replacement content for presentation in the user interface.

### BACKGROUND

A graphical user interface is a form of user interface that allows users to interact with electronic devices. A web browser may provide a graphical user interface that presents web pages. A user may navigate to a web page by entering a web address into an address bar of the web browser and/or by clicking a link displayed via another web page. Navigation to a web page may consume resources of a client device on which the web browser is installed, may consume resources of a web server that serves the web page to the client device, and may consume network resources used for communications between the client device and the web server.

### SUMMARY

Some implementations described herein relate to a system for using interaction data to dynamically replace content in a document object model (DOM). The system may include one or more memories and one or more processors communicatively coupled to the one or more memories. The one or more processors may be configured to receive a web page that includes code, and includes content organized in a plurality of containers of a DOM associated with the web page. The one or more processors may be configured to render, in connection with an initial page load, the web page for presentation in a user interface. The one or more processors may be configured to monitor interaction data relating to a use of the user interface, where the interaction data relates to one or more of scrolling behavior or inactivity behavior. The one or more processors may be configured to identify, in accordance with the interaction data, a container of the plurality of containers of the DOM that contains original content that is to be replaced. The one or more processors may be configured to duplicate, responsive to identification of the container, the original content into a hidden container of the DOM. The one or more processors may be configured to load, using the code and asynchronously to the initial page load, replacement content into the container of the DOM to replace the original content with the replacement content for presentation in the user interface. The one or more processors may be configured to determine, in accordance with the interaction data, that the container is to revert to the original content. The one or more processors may be configured to insert, responsive to a determination that the container is to revert to the original content, the original content from the hidden container of the DOM into the container of the DOM to replace the replacement content with the original content for presentation in the user interface.

Some implementations described herein relate to a method of using interaction data to dynamically replace content in a DOM. The method may include receiving a web page that includes content organized in a plurality of containers of a DOM associated with the web page. The method may include rendering, in connection with an initial page load, the web page for presentation in a user interface. The method may include monitoring interaction data relating to a use of the user interface. The method may include identifying, in accordance with the interaction data, a container of the plurality of containers of the DOM that contains original content that has been viewed. The method may include loading, asynchronously to the initial page load, replacement content into the container of the DOM to replace the original content with the replacement content for presentation in the user interface.

Some implementations described herein relate to a non-transitory computer-readable medium that stores a set of instructions for using interaction data to dynamically replace content in a DOM. The set of instructions, when executed by one or more processors of a device, may cause the device to receive a web page that includes content organized in a plurality of containers of a DOM associated with the web page. The set of instructions, when executed by one or more processors of the device, may cause the device to render, in connection with an initial page load, the web page for presentation in a user interface. The set of instructions, when executed by one or more processors of the device, may cause the device to monitor scrolling behavior relating to a use of the user interface. The set of instructions, when executed by one or more processors of the device, may cause the device to identify, in accordance with the scrolling behavior, a container of the plurality of containers of the DOM that contains original content that has been viewed. The set of instructions, when executed by one or more processors of the device, may cause the device to load, asynchronously to the initial page load, replacement content into the container of the DOM to replace the original content with the replacement content for presentation in the user interface.

### BRIEF DESCRIPTION OF THE DRAWINGS

FIGS. 1A-1F are diagrams of an example associated with using interaction data to dynamically replace content in a DOM, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with using interaction data to dynamically replace content in a DOM, in accordance with some embodiments of the present disclosure.

FIG. 4 is a flowchart of an example process associated with using interaction data to dynamically replace content in a DOM, in accordance with some embodiments of the present disclosure.

### DETAILED DESCRIPTION

The following detailed description of example implementations refers to the accompanying drawings. The same reference numbers in different drawings may identify the same or similar elements.

A web page provides an interface for accessing information and/or services on the Internet. A web page may incorporate content that is to be displayed in a user interface, such as a web browser. Sometimes, a web page may employ overlays, sidebars, or the like, to display content that is supplemental to a main content of the web page. These overlays, sidebars, and similar structures, along with the supplemental content, can be statically integrated into a web page and pre-loaded at a time of an initial page load, thereby making these elements available for immediate display upon the initial page load. However, this practice increases a size of the web page, and as a result increases page load times, increases processing burdens on client devices and web servers, and taxes network bandwidth. Moreover, because supplemental content is often viewed only after the main content of the web page is viewed, pre-loading the supplemental content and its associated structural elements is an inefficient use of the web page.

Some implementations described herein enable dynamically replacing content in a web page in accordance with interaction data relating to a use of a user interface, such as data relating to scrolling behavior or inactivity behavior, among other examples. For example, after rendering a web page for presentation in a user interface, a user device may monitor the interaction data associated with a user to identify when original content of a container, of a DOM associated with the web page, has been viewed (e.g., consumed) by the user. Asynchronously to the initial page load, the user device may load replacement content into the container to replace the original content with the replacement content. The replacement content may occupy a same region of the user interface that was occupied by the original content, such that the original content is seamlessly swapped for the replacement content within the layout of the web page.

In some implementations, before swapping the original content with the replacement content, the user device may preserve the original content in a hidden container of the DOM. After the original content has been swapped with the replacement content, the user device can further use the interaction data to detect an intent of the user to re-engage with the original content. Accordingly, the user device can revert the container to the original content using the original content preserved in the hidden container.

By loading the replacement content asynchronously to the initial page load, both the original content and the replacement content can be presented by the web page while reducing the size of the web page. In this way, an initial load time of the web page is decreased, and processing tasks of the user device and a web server that served the web page, as well as network resource usage, are more evenly distributed. Moreover, timing a swap of the original content and the replacement content based on whether the user has viewed the original content is a more efficient use of the web page and a more efficient use of the limited viewing area of the user interface. Furthermore, by preserving the original content in a hidden container, the container can be reverted to the original content without additional communication between the user device and the web server, thereby conserving computing resources of the user device and the web server as well as conserving network resources.

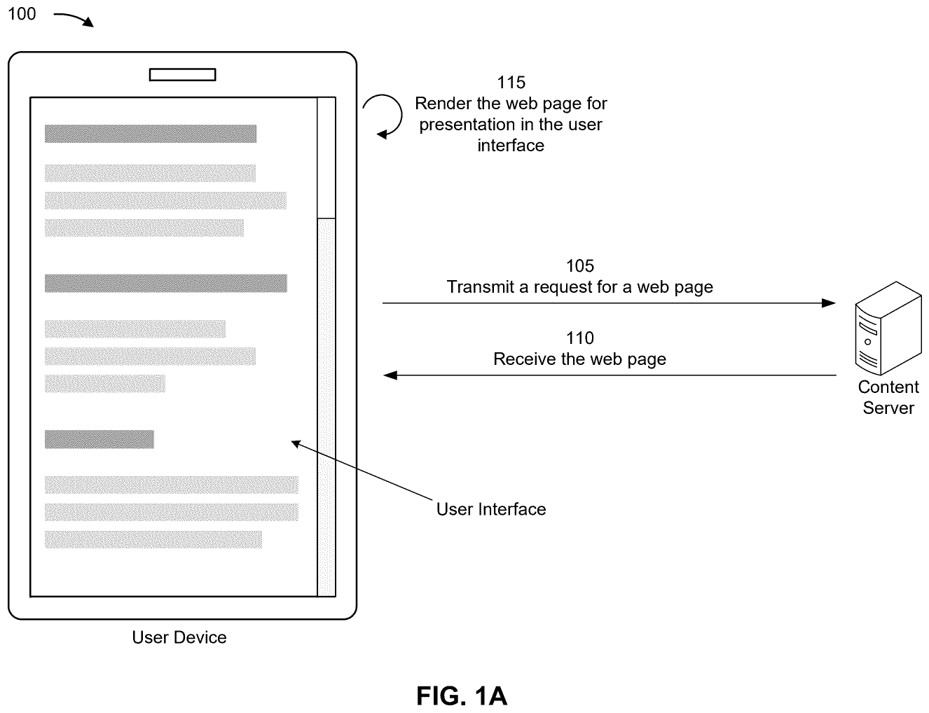

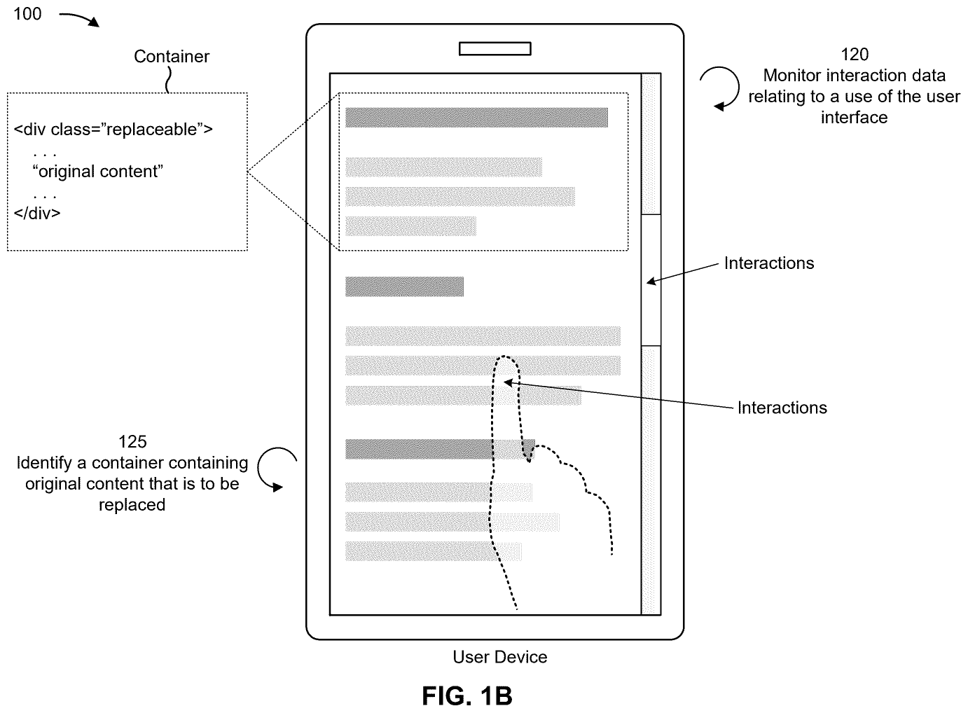

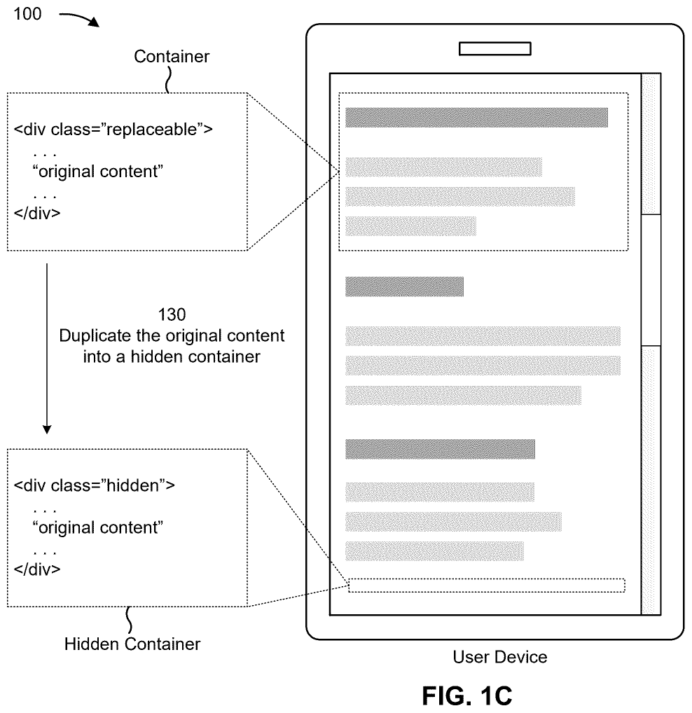

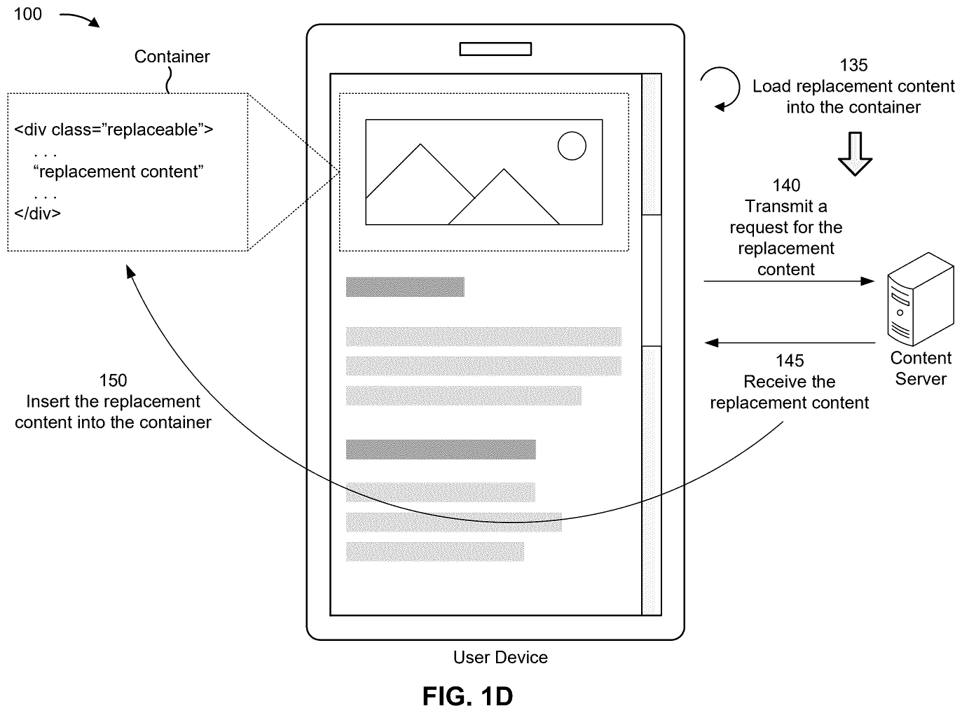

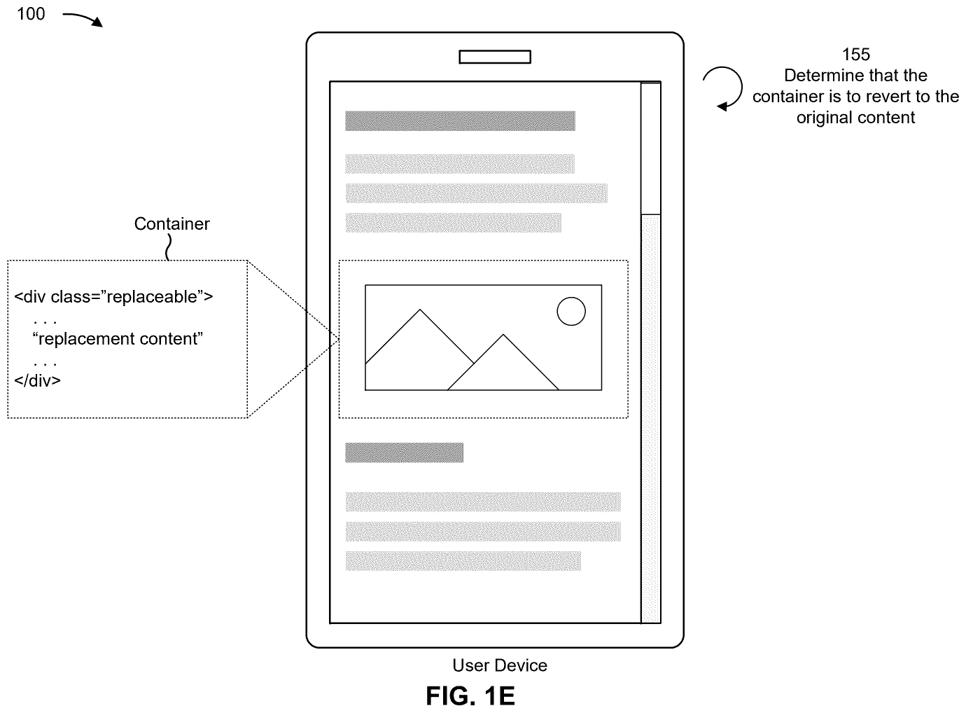

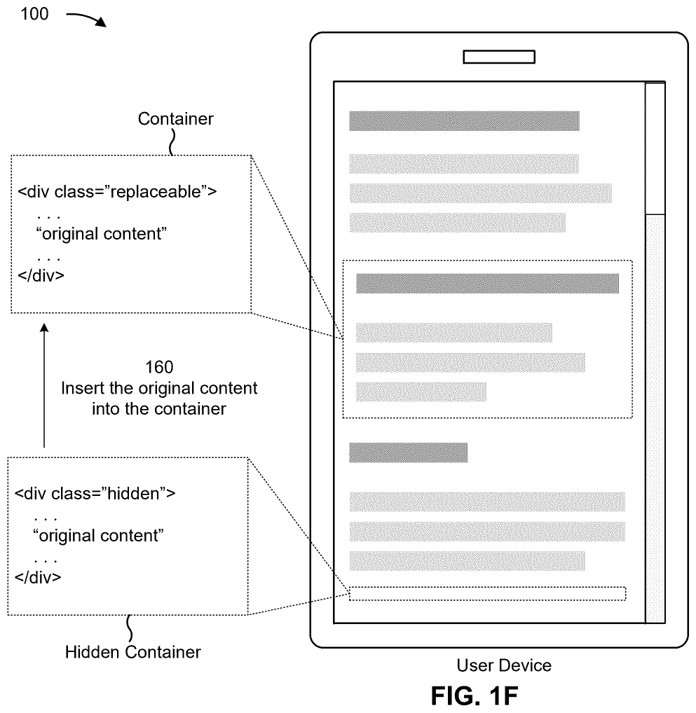

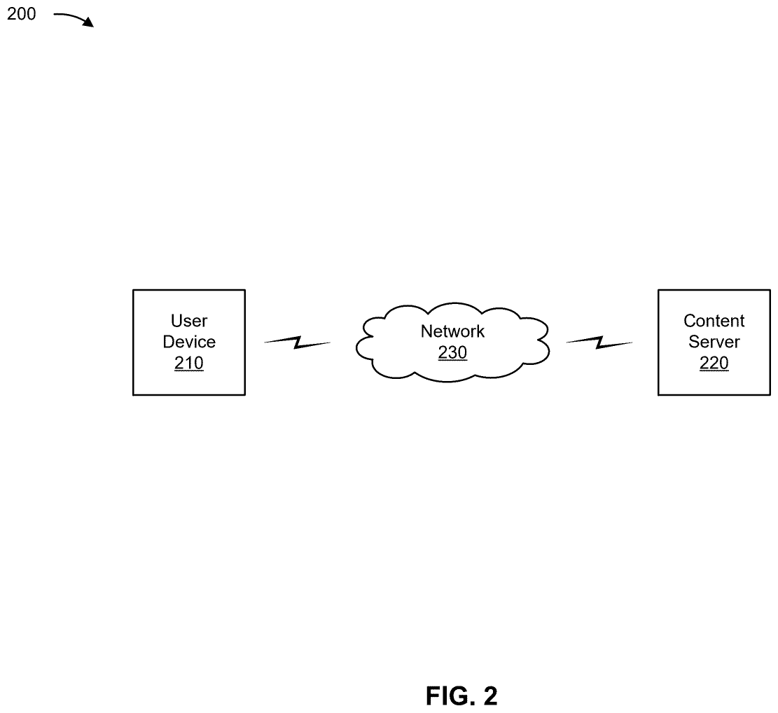

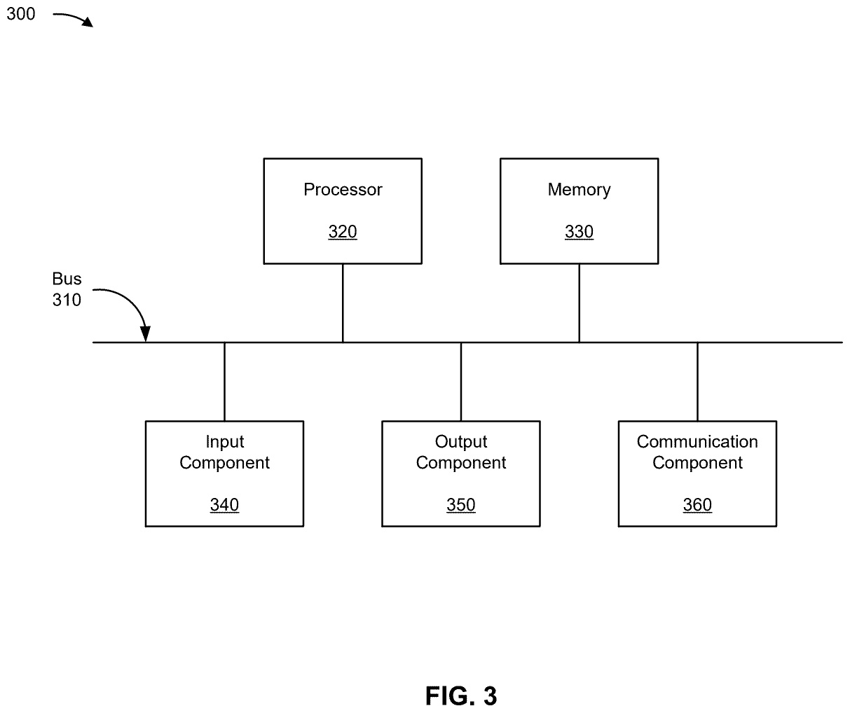

FIGS. 1A-1F are diagrams of an example 100 associated with using interaction data to dynamically replace content in a DOM. As shown in FIGS. 1A-1F, example 100 includes a user device and a content server. These devices are described in more detail in connection with FIGS. 2 and 3. The user device may be associated with a user. The user device may implement a user interface (e.g., a graphical user interface), such as a web browser. For example, the user device may include a web browser application, which the user device may execute to load web pages.

As shown in FIG. 1A, and by reference number 105, the user device may transmit, to the content server, a request for a web page. For example, the request may be a hypertext transfer protocol (HTTP) request that indicates an identifier (e.g., a uniform resource locator (URL)) of the web page. As shown by reference number 110, the user device may receive the web page from the content server. The web page may relate to a news article, a blog post, information for a product or service, or the like. The web page may include code (e.g., client-side code, such as JavaScript code) configured to execute asynchronously with a loading of the web page. Moreover, the web page may be associated with a DOM that provides a hierarchical structure of the web page, which may be indicative of a visual layout of the web page. The web page may include content organized in a plurality of containers of the DOM (e.g., using “DIV” hypertext markup language (HTML) tags). The content may include text, one or more images, and/or one or more videos (e.g., in one or more embedded video players), among other examples.

In some implementations, each of the containers may be associated with a respective set of style settings (e.g., cascading style sheet (CSS) styles), which define a visual appearance of the web page. In some implementations, a container (e.g., one or more of the containers) may have an attribute indicating that the container contains replaceable content. For example, a style “class” attribute of a container may be set as a particular class (e.g., set to a particular name) to indicate that the container contains replaceable content.

As shown by reference number 115, the user device may render the web page for presentation in the user interface (e.g., the web browser). For example, the user device may render the web page in connection with an initial page load of the web page on the user device. To render the web page, the user device (e.g., using the user interface) may parse (e.g., interpret) HTML of the web page, construct the DOM based on the HTML, apply style settings (e.g., CSS styles) to elements in the DOM, execute code of the web page (e.g., which may modify the DOM or style settings), and/or display the web page in the user interface (e.g., based on the DOM, the style settings, and the executed code).

As shown in FIG. 1B, and by reference number 120, the user device may monitor interaction data relating to the user's use of the user interface (e.g., with the web page loaded therein). For example, the user device may monitor the interaction data using the code of the web page. The interaction data may relate to scrolling behavior (e.g., scroll depth), inactivity behavior (e.g., user inactivity or browser tab inactivity), clicking behavior (e.g., where, in the user interface, mouse clicks occur; how often mouse clicks occur, or the like), touch gesture (e.g., tapping, swiping, or the like) behavior (e.g., where, in the user interface, touch gestures occur; how often touch gestures occur; what types of touch gestures are used, or the like), text selection behavior (e.g., where, in the user interface, text is selected; how often text is selected, or the like), and/or text input behavior (e.g., where, in the user interface, text is input; how often text is input, or the like), among other examples. The user device may monitor the interaction data continuously while the web page is presented in the user interface.

As shown by reference number 125, the user device may identify a container of the DOM containing original content that is to be replaced. For example, the user device may identify a container of the DOM containing original content that has been viewed (e.g., consumed, read, scrolled past, or the like) by the user. The user device may identify the container based on the interaction data. As an example, whether the original content has been “viewed” by the user is an estimate based on the interaction data, and is unrelated to whether or not the user has actually viewed the original content. In some implementations, the container that is identified has an attribute indicating that the container contains replaceable content (e.g., for purposes of container identification, the user device can ignore containers that are lacking an indication of replaceable content).

In some implementations, the user device may identify, in accordance with scrolling behavior, that a container has been scrolled past a scrolling threshold in a viewport of the user interface (e.g., a halfway point of the viewport), and the user device may identify that the original content of that container has been viewed by the user. For example, using a calculated layout of the web page (e.g., based on the DOM and/or the style settings), the user device may identify an overall height of the container, and the user device may use the overall height to identify whether the container has been scrolled past the scrolling threshold. In some implementations, the user device may identify, in accordance with inactivity behavior, that a container has been in a viewport of the user interface (e.g., of an active tab or an inactive tab of the user interface) for a period of inactivity that satisfies an inactivity threshold (e.g., 1 minute), and the user device may identify that the original content of that container has been viewed by the user. In some implementations, the user device may identify that a container contains original content that is to be replaced (e.g., regardless of whether the original content has been determined to have been viewed) based on a period of inactivity in the user interface satisfying the inactivity threshold and/or based on an active tab of the user interface being changed to an inactive tab of the user interface.

In some implementations, the conditions or a timing at which the user device may identify that the original content has been viewed, and which allow the user device to identify the container, may be based on the interaction data (e.g., the conditions or the timing may be particular to the user). For example, based on the interaction data, the user device may build a user profile for the user, indicating the user's tendencies for interacting with the user interface, which may indicate a probability of whether the user has viewed content (e.g., the user may scroll continuously while reading a block of text, or the user may scroll through a block of text only after completely reading the block of text). Accordingly, the user device may use the user profile to determine the scrolling threshold, the inactivity threshold, or other thresholds or conditions for identifying when the original content has been viewed by the user.

In some implementations, as shown in FIG. 1C, and by reference number 130, responsive to identifying the container, the user device may duplicate the original content into a hidden container of the DOM. The hidden container may be a placeholder container that allows the original content, in its current state, to be preserved during subsequent operations described herein. The hidden container may have style settings configured to hide the hidden container (e.g., make the hidden container invisible to the user) in the user interface.

As shown in FIG. 1D, and by reference number 135, the user device may load replacement content into the container. For example, the user device, using the code, may load the replacement content into the container asynchronously to the initial page load. Loading the replacement content into the container replaces the original content with the replacement content for presentation in the user interface (e.g., the original content is swapped out for the replacement content). In some implementations, the code and/or the replacement content may be configured to swap the original content for the replacement content using an animated transition. The replacement content may be supplemental content to the original content, such as call-to-action content, advertisement content, text content, image content, video content, augmented reality content, or the like.

The user device may load the replacement content into the container in accordance with a timing that is based on the interaction data. For example, the user device may use the user profile, described herein, to determine the timing for replacing the original content with the replacement content. As an example, the user device may use the interaction data (e.g., the user profile) to identify a behavior pattern (e.g., including scrolling behavior, inactivity behavior, and/or clicking behavior, among other examples) indicative of the user shifting attention from the original content to different content, and the user device may time a swapping of the original content with the replacement content to coincide with detection of the behavior pattern. In this way, the timing facilitates less intrusive swapping of the original content for the replacement content.

In some implementations, by loading the replacement content into the container, the replacement content inherits the style settings of the container. In some implementations, by loading the replacement content into the container, the replacement content occupies a same region of the user interface that was occupied by the original content. Thus, the replacement content may occupy the same space of the user interface formerly occupied by the original content.

In some implementations, to load the replacement content, the user device may transmit a request (e.g., using the code, and asynchronously to the initial page load) for replacement content to the content server, as shown by reference number 140, and the user device may receive the replacement content from the content server, as shown by reference number 145. In some implementations, the request may indicate the original content (e.g., the request may include the original content or may include an identifier, such as a container identifier, that allows the content server to identify the original content based on the identifier), and the replacement content may be based on a context of the original content. For example, the content server may process the original content using a keyword extraction technique, a natural language processing technique, an image recognition technique, or the like, to determine the context of the original content (e.g., a topic to which the original content relates). Continuing with the example, the content server may generate the replacement content, or select the replacement content from a set of options, based on the determined context.

In addition, to load the replacement content, the user device may insert (e.g., using the code) the replacement content into the container to replace the original content with the replacement content, as shown by reference number 150. For example, the user device may insert the replacement content into the container once the replacement content has been received from the content server. The user device may insert the replacement content into the container by manipulating (e.g., performing operations on) the DOM associated with the web page. In some implementations, loading the replacement content may include inserting the replacement content into a staging container of the DOM, and loading (e.g., inserting) the replacement content from the staging container into the container. The staging container may be hidden in the user interface, in a similar manner as the hidden container described herein.

In some implementations, the user device may obtain the replacement content and insert the replacement content into the staging container prior to identifying that the original content in the container has been viewed. For example, the user device may obtain the replacement content and insert the replacement content into the staging container based on identifying that the original content in the container has been nearly viewed (e.g., scrolling through the container is approaching the scrolling threshold or a period of inactivity is approaching the inactivity threshold). In this way, the replacement content may be pre-loaded into the web page, thereby reducing lag time associated with replacing the original content with the replacement content.

After the original content has been replaced with the replacement content, the user device may continue to monitor the interaction data (e.g., scrolling behavior and/or interactivity behavior), and the user device may determine, in accordance with the interaction data, that the container is to revert to the original content, as shown in FIG. 1E and by reference number 155. As an example, the user device may determine, in accordance with the interaction data (e.g., relating to inactivity behavior), that activity in the user interface has resumed after a period of inactivity (e.g., the user has resumed activity in the user interface, or the user has re-activated an inactive tab of the user interface), which may indicate that the container is to revert to the original content. As another example, the user device may determine, in accordance with the interaction data (e.g., relating to scrolling behavior), that the user interface was reverse scrolled to the container and/or that the user interface has remained scrolled to the container for a threshold amount of time, which may indicate that the container is to revert to the original content. In other examples, the interaction data indicating clicking performed in the container, touch gestures performed in the container, text selections in the container, or other behaviors may indicate that the container is to revert to the original content.

As shown in FIG. 1F, and by reference number 160, the user device may insert the original content into the container. For example, the user device, using the code, may insert the original content into the container asynchronously to the initial page load. In particular, the user device may insert the original content from the hidden container into the container. Inserting the original content into the container replaces the replacement content with the original content for presentation in the user interface (e.g., the replacement content is swapped out for the original content). The user device may insert the original content into the container responsive to determining that the container is to revert to the original content.

In some implementations, the user device and/or the content server may gather data relating to user engagement with the replacement content (e.g., clicking on the replacement content, selecting text in the replacement content, or the like) and/or gather the interaction data (e.g., relating to reverse scrolling behavior and/or inactivity behavior, among other examples) for a time period while the replacement content is present in the container. The data and/or interaction data may be processed by the content server or another server utilizing one or more machine learning models. The machine learning model(s) may be configured to identify improvements to a relevance of replacement content and/or to a timing for displaying replacement content using the data and/or the interaction data. The machine learning model(s) may identify the improvements based on a feature set relating to user-engagement patterns, scrolling behavior, inactivity behavior, and/or interactive transition points, among other examples.

By loading the replacement content asynchronously to the initial page load, both the original content and the replacement content can be presented by the web page while reducing the size of the web page. In this way, an initial load time of the web page is decreased, and processing tasks of the user device and a web server that served the web page, as well as network bandwidth usage, are more evenly distributed. Moreover, timing a swap of the original content and the replacement content based on whether the user has viewed the original content is a more efficient use of the web page and a more efficient use of the limited viewing area of the user interface.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a user device 210, a content server 220, and a network 230. Devices of environment 200 may interconnect via wired connections, wireless connections, or a combination of wired and wireless connections.

The user device 210 may include one or more devices capable of receiving, generating, storing, processing, and/or providing information associated with replacing content in a DOM, as described elsewhere herein. The user device 210 may include a communication device and/or a computing device. For example, the user device 210 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The content server 220 may include one or more devices capable of receiving, generating, storing, processing, providing, and/or routing information associated with replacing content in a DOM, as described elsewhere herein. The content server 220 may include a communication device and/or a computing device. For example, the content server 220 may include a server, such as an application server, a client server, a web server, a database server, a host server, a proxy server, a virtual server (e.g., executing on computing hardware), or a server in a cloud computing system. In some implementations, the content server 220 may include computing hardware used in a cloud computing environment.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with using interaction data to dynamically replace content in a DOM. The device 300 may correspond to user device 210 and/or content server 220. In some implementations, user device 210 and/or content server 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

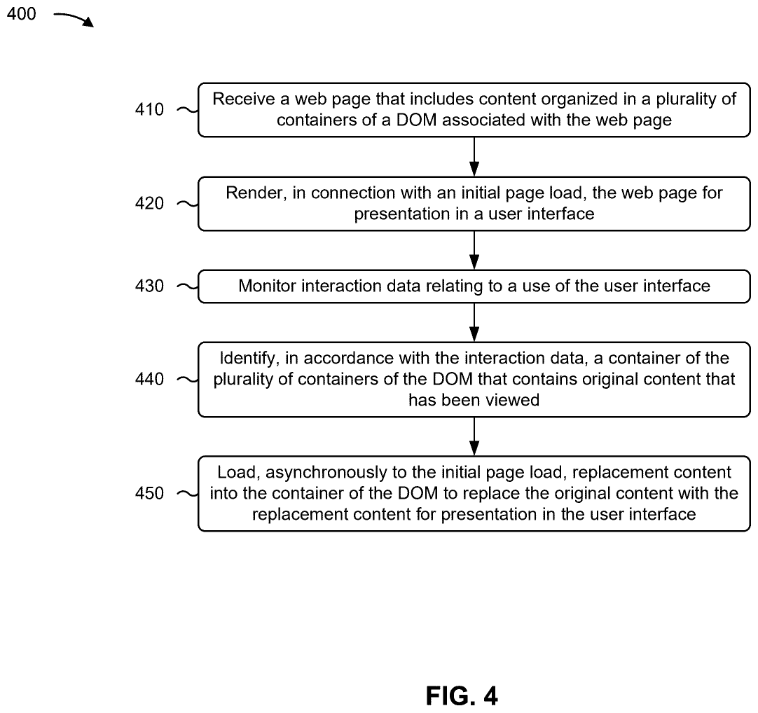

FIG. 4 is a flowchart of an example process 400 associated with using interaction data to dynamically replace content in a DOM. In some implementations, one or more process blocks of FIG. 4 may be performed by the user device 210. In some implementations, one or more process blocks of FIG. 4 may be performed by another device or a group of devices separate from or including the user device 210, such as the content server 220. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a web page that includes content organized in a plurality of containers of a DOM associated with the web page (block 410). For example, the user device 210 (e.g., using processor 320, memory 330, and/or communication component 360) may receive a web page that includes content organized in a plurality of containers of a DOM associated with the web page, as described above in connection with reference number 110 of FIG. 1A. As an example, the web page may include content organized in a plurality of containers of the DOM.

As further shown in FIG. 4, process 400 may include rendering, in connection with an initial page load, the web page for presentation in a user interface (block 420). For example, the user device 210 (e.g., using processor 320 and/or memory 330) may render, in connection with an initial page load, the web page for presentation in a user interface, as described above in connection with reference number 115 of FIG. 1A. As an example, rendering the web page may include interpreting HTML of the web page, constructing the DOM based on the HTML, applying style settings to elements in the DOM, executing code of the web page, and/or displaying the web page in the user interface.

As further shown in FIG. 4, process 400 may include monitoring interaction data relating to a use of the user interface (block 430). For example, the user device 210 (e.g., using processor 320 and/or memory 330) may monitor interaction data relating to a use of the user interface, as described above in connection with reference number 120 of FIG. 1B. As an example, the interaction data may relate to scrolling behavior, inactivity behavior, clicking behavior, touch gesture behavior, text selection behavior, and/or text input behavior, among other examples.

As further shown in FIG. 4, process 400 may include identifying, in accordance with the interaction data, a container of the plurality of containers of the DOM that contains original content that has been viewed (block 440). For example, the user device 210 (e.g., using processor 320 and/or memory 330) may identify, in accordance with the interaction data, a container of the plurality of containers of the DOM that contains original content that has been viewed, as described above in connection with reference number 125 of FIG. 1B. As an example, scrolling behavior may indicate that a container has been scrolled past a scrolling threshold in a viewport of the user interface (e.g., a halfway point of the viewport), which may indicate that the original content of that container has been viewed.

As further shown in FIG. 4, process 400 may include loading, asynchronously to the initial page load, replacement content into the container of the DOM to replace the original content with the replacement content for presentation in the user interface (block 450). For example, the user device 210 (e.g., using processor 320, memory 330, and/or communication component 360) may load, asynchronously to the initial page load, replacement content into the container of the DOM to replace the original content with the replacement content for presentation in the user interface, as described above in connection with reference number 135 of FIG. 1D. As an example, the replacement content may be loaded into the container in accordance with a timing that is based on the interaction data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using interaction data to dynamically replace content in a document object model, the system comprising:
one or more memories; and
one or more processors, communicatively coupled to the one or more memories, configured to:
receive a web page that includes code, and includes content organized in a plurality of containers of a document object model (DOM) associated with the web page;
render, in connection with an initial page load, the web page for presentation in a user interface;
monitor interaction data relating to a use of the user interface,
wherein the interaction data relates to one or more of scrolling behavior or inactivity behavior;
identify, in accordance with the interaction data, a container of the plurality of containers of the DOM that contains original content that is to be replaced;
duplicate, responsive to identification of the container, the original content into a hidden container of the DOM;
load, using the code and asynchronously to the initial page load, replacement content into the container of the DOM to replace the original content with the replacement content for presentation in the user interface;
determine, in accordance with the interaction data, that the container is to revert to the original content; and
insert, responsive to a determination that the container is to revert to the original content, the original content from the hidden container of the DOM into the container of the DOM to replace the replacement content with the original content for presentation in the user interface.

2. The system of claim 1, wherein the one or more processors, to load the replacement content into the container, are configured to:
insert the replacement content into a staging container of the DOM; and
load the replacement content from the staging container into the container.

3. The system of claim 1, wherein the one or more processors, to load the replacement content into the container, are configured to:
load the replacement content into the container in accordance with a timing that is based on the interaction data.

4. The system of claim 1, wherein the one or more processors, to load the replacement content into the container, are configured to:
transmit a request for the replacement content to a content server;
receive the replacement content from the content server; and
insert the replacement content into the container of the DOM to replace the original content with the replacement content for presentation in the user interface.

5. The system of claim 4, wherein the request indicates the original content, and
wherein the replacement content is based on a context of the original content.

6. The system of claim 1, wherein the original content and the replacement content are to occupy a same region of the user interface.

7. The system of claim 1, wherein the one or more processors, to determine that the container is to revert to the original content, are configured to:
determine, in accordance with the interaction data, that activity in the user interface has resumed after a period of inactivity.

8. The system of claim 1, wherein the one or more processors, to determine that the container is to revert to the original content, are configured to:
determine, in accordance with the interaction data, that the user interface was reverse scrolled to the container or that the user interface has remained scrolled to the container for a threshold amount of time.

9. A method of using interaction data to dynamically replace content in a document object model, comprising:
receiving a web page that includes content organized in a plurality of containers of a document object model (DOM) associated with the web page;
rendering, in connection with an initial page load, the web page for presentation in a user interface;
monitoring interaction data relating to a use of the user interface;
identifying, in accordance with the interaction data, a container of the plurality of containers of the DOM that contains original content that has been viewed; and
loading, asynchronously to the initial page load, replacement content into the container of the DOM to replace the original content with the replacement content for presentation in the user interface.

10. The method of claim 9, wherein loading the replacement content into the container comprises:
transmitting a request for the replacement content to a content server;
receiving the replacement content from the content server; and
inserting the replacement content into the container of the DOM to replace the original content with the replacement content for presentation in the user interface.

11. The method of claim 9, further comprising:
duplicating the original content into a hidden container of the DOM;
determining, in accordance with the interaction data, that activity in the user interface has resumed after a period of inactivity; and
inserting, responsive to a determination that activity in the user interface has resumed, the original content from the hidden container of the DOM into the container of the DOM to replace the replacement content with the original content for presentation in the user interface.

12. The method of claim 9, wherein the interaction data relates to one or more of:
scrolling behavior,
inactivity behavior,
clicking behavior,
touch gesture behavior,
text selection behavior, or
text input behavior.

13. The method of claim 9, wherein the interaction data relates to scrolling behavior, and
wherein identifying the container comprises:
identifying, in accordance with the scrolling behavior, that the container has been scrolled past a scrolling threshold in a viewport of the user interface.

14. The method of claim 9, wherein the interaction data relates to inactivity behavior, and
wherein identifying the container comprises:
identifying, in accordance with the inactivity behavior, that a period of inactivity in the user interface, while the container is in a viewport of the user interface, satisfies an inactivity threshold.

15. The method of claim 9, wherein the original content and the replacement content occupy a same region of the user interface.

16. A non-transitory computer-readable medium storing a set of instructions for using interaction data to dynamically replace content in a document object model, the set of instructions comprising:
one or more instructions that, when executed by one or more processors of a device, cause the device to:
receive a web page that includes content organized in a plurality of containers of a document object model (DOM) associated with the web page;
render, in connection with an initial page load, the web page for presentation in a user interface;
monitor scrolling behavior relating to a use of the user interface;
identify, in accordance with the scrolling behavior, a container of the plurality of containers of the DOM that contains original content that has been viewed; and
load, asynchronously to the initial page load, replacement content into the container of the DOM to replace the original content with the replacement content for presentation in the user interface.

17. The non-transitory computer-readable medium of claim 16, wherein the one or more instructions, when executed by the one or more processors, further cause the device to:
duplicate the original content into a hidden container of the DOM;
determine, in accordance with the scrolling behavior, that the user interface was reverse scrolled to the container or that the user interface has remained scrolled to the container for a threshold amount of time; and
insert, responsive to a determination that the user interface was reverse scrolled to the container or that the user interface has remained scrolled to the container for the threshold amount of time, the original content from the hidden container of the DOM into the container of the DOM to replace the replacement content with the original content for presentation in the user interface.

18. The non-transitory computer-readable medium of claim 16, wherein the one or more instructions, that cause the device to load the replacement content into the container, cause the device to:
transmit a request for the replacement content to a content server;
receive the replacement content from the content server; and
insert the replacement content into the container of the DOM to replace the original content with the replacement content for presentation in the user interface.

19. The non-transitory computer-readable medium of claim 16, wherein the container is configured with one or more style settings, and
wherein the replacement content is to inherit the one or more style settings.

20. The non-transitory computer-readable medium of claim 16, wherein the original content and the replacement content occupy a same region of the user interface.
